(19) United States
(12) Patent Application Publication
(10) Pub. No.: US 2010/0267279 A1
(43) Pub. Date: Oct. 21, 2010

(54) POWER RECEPTACLE

(75) Inventors: Edward John Burak, Raumati South (NZ); Thomas David De Groen, Wellington (NZ)

Correspondence Address: Workman Nydegger;1000 Eagle Gate Tower, 60 East South Temple, Salt Lake City, UT, 84111, US

(73) Assignee: FORMWAY FURNITURE LIMITED, Wellington (NZ)

(21) Appl. No.: 12/444,127

(22) PCT Filed: Oct. 5, 2007
(86) PCT No.: PCT/NZ2007/000293

§ 371 Date: Jun. 22, 2010

Related U.S. Application Data
(60) Provisional application No. 60/829,641, filed on Oct. 16, 2006.

(51) Int. Cl. H01R 13/60

(52) U.S. Cl. 439/540.1; 439/527

(57) ABSTRACT

A power receptacle suitable for desktop use. The power receptacle has a casing (3) with a plurality of exterior walls. At least one socket (33, 35, 37) is accessible from the exterior of the casing. The socket(s) is/are configured to receive a power plug of a device to be powered which plug is in electrical connection with a power cord for the device. The casing may have walls and a cavity within the casing, with the cavity accessible from an exterior of the casing via an opening (7c). The cavity is configured to receive part of the power cord of the device. At least one exterior surface of the casing may be formed of an elastomeric material. A plurality of sockets (33, 35, 37) may be in an exterior wall of the casing, with each socket oriented in the wall on an angle relative to any adjacent socket.

### FIELD OF THE INVENTION

The invention relates to receptacles for transferring AC power to powered devices.

### BACKGROUND TO THE INVENTION

Power receptacles are used to deliver power to powered devices. The receptacles may be fixed to a wall or other item, or may be portable. A power cord extends from the power receptacle and a plug at an end of the power cord can be connected to a powered socket to deliver power to the receptacle. The receptacle contains a socket, and a plug of a device to be powered can be connected with the socket in the receptacle to deliver power to the device.

With the increasing use of electrical and electronic goods, it is often necessary to use a receptacle of the type referred to as a “multi-box”. A multi-box power receptacle contains multiple sockets, so power can be delivered from one wall socket to multiple devices at any one time.

While such power receptacles readily enable devices to be powered, each of the devices to be powered will generally have its own power cord, which will extend from the receptacle to the device being powered. That can create cable clutter, especially when the power receptacle is used in an area with restricted space.

It is an object of at least preferred embodiments of the present invention to provide a power receptacle that addresses the disadvantage outlined above, or that at least provides the public with a useful choice.

### SUMMARY OF THE INVENTION

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

In accordance with a first aspect of the present invention, there is provided a power receptacle suitable for desktop use for delivering power to at least one device to be powered, the power receptacle comprising: a casing having a plurality of exterior walls and a cavity within the casing, wherein the cavity is accessible from an exterior of the casing via an opening in the casing; and at least one socket accessible from the exterior of the casing, the socket configured to receive a power plug of a device to be powered which plug is in electrical connection with a power cord for the device; wherein the cavity is configured to receive part of the power cord of the device.

The power receptacle may be provided with a power cord to electrically connect the receptacle to a power socket such as a wall socket or a power socket in an item of furniture such as a workstation or the like. The power cord may be “hard wired” into the receptacle—that is it may be permanently connected to the receptacle. Alternatively, the power cord may be disconnectable from the receptacle, and optionally may be interchangeable with an alternative power cord for use in a different country for example.

The casing preferably comprises at least a front exterior wall and a rear exterior wall. The socket(s) may be provided in the front exterior wall. In that configuration, the opening for access to the cavity is preferably provided in a portion of the casing other than the rear exterior wall. Preferably, the casing further comprises at least one side exterior wall between the front exterior wall and the rear exterior wall, and the opening is preferably provided in the side exterior wall.

Preferably, a major part of the casing is formed by the cavity. The socket(s) is/are preferably provided in a power supply section at or toward an edge of the casing, and substantially the remainder of the interior of the casing may comprise the cavity.

The casing may be provided with a flap to at least partly cover the opening to the cavity. Preferably, the flap is biased toward a closed position in which it at least partly covers the cavity, so that the flap can apply pressure against a power cord extending through the opening to minimise undesired movement of the power cord.

The flap is preferably formed of a resilient material, and the resilience of the material biases the flap toward the closed position. The material may be an elastomer, such as rubber or any elastomeric polymer of any suitable type, such as thermoplastic polyurethane elastomer (TPU), silicon, or latex for example.

Instead of the resilience of the material providing the biasing, the flay may be substantially rigid and spring biased towards the closed position.

The casing may be provided with a pair of opposing flaps, and the flaps may define the opening therebetween.

The opening is preferably an elongate slit that extends a major part of the length of a side wall.

The receptacle may comprise a plurality of sockets to enable a plurality of devices to be powered at any one time. While the sockets may be provided in different exterior walls of the device—such as one socket per wall—the sockets are preferably provided in a single exterior wall of the device. At least two of the sockets are preferably provided on different orientations in that wall to accommodate plugs of different configurations. For example, the two sockets may be oriented generally perpendicularly to one another. Preferably, the receptacle comprises at least three sockets, each of which is provided on a different orientation from the other sockets. Preferably, each socket is oriented generally perpendicularly to an adjacent socket.

The or each socket may be a “hot” socket. That is, when the receptacle is electrically connected to a power source, power is delivered to the socket. Alternatively, the or each socket may be switched, so power can be selectively delivered to the or each power source. A single switch may control all sockets, or individual switches may be provided for each socket. Alternatively, the receptacle may be provided with a combination of switched and hot sockets.

At least one exterior surface of the casing is preferably formed of an elastomeric material. Preferably, the surface comprising the socket(s) is formed of an elastomeric material. More preferably, all exterior surfaces of the casing may be formed of an elastomeric material. The material may be rubber or an elastomeric polymer of any suitable type, such as those outlined above for example.

The device may comprise an indicator to indicate when it is plugged in and powered. The indicator may comprise an LED for example. Preferably the LED is visible around the point of insertion of the power cord of the receptacle into the casing.

The device may be provided with an indicator for the or each socket that indicates when a device is plugged into the socket(s) and is being powered. The indicator(s) may comprise LED(s) for example. The indicator(s) could be provided in any suitable external wall of the casing.

While in the form shown the receptacle casing is a cuboid shape, the receptacle casing could be an alternative shape. By way of example only, the front and rear surface could have a round or elliptical shape, and a single side wall could form a perimeter between the front and rear surfaces. However, it is preferred that the receptacle casing has the exterior shape shown or similar, so it can be rested on a desktop or similar on its rear wall, or can be positioned in an upright configuration on a shelf. Preferably, the wall opposite the wall with the socket(s) and the side wall closest to the socket(s) are each substantially planar.

The power receptacle may additionally be configured to provide a data connection.

In accordance with a second aspect of the present invention, there is provided a power receptacle suitable for desktop use for delivering power to at least one device to be powered, the power receptacle comprising: a casing having a plurality of exterior walls; and at least one socket accessible from the exterior of the casing, the socket configured to receive a power plug of a device to be powered; wherein at least one exterior surface of the casing is formed of an elastomeric material.

Preferably, at least the exterior surface corresponding to the socket is formed of an elastomeric material. Preferably, the exterior wall corresponding to the socket(s) is generally planar, to provide a surface upon which at least one device to be powered can be supported. Preferably, the exterior wall opposite the exterior wall corresponding to the socket(s) is generally planar, to provide a surface upon which the power receptacle can rest.

Preferably, the socket(s) is/are provided in a wall adjacent the edge of that wall, and an adjacent wall is generally planar, to provide a surface upon which the power receptacle can rest.

Preferably, all exterior walls of the casing are formed of an elastomeric material.

In accordance with a third aspect of the present invention, there is provided a power receptacle suitable for desktop use for delivering power to at least one device to be powered, the power receptacle comprising: a casing having a plurality of exterior walls; and a plurality of sockets in an exterior wall of the casing, wherein each socket is oriented in the wall on an angle relative to any adjacent socket, the sockets each configured to receive a power plug of a respective device to be powered.

Preferably, the sockets are provided in a power supply section at or toward one edge of the casing.

Preferably, each socket is/are oriented generally perpendicularly to an adjacent socket.

Preferably, the power receptacle comprises at least three sockets, each of which is provided on a different orientation from the other sockets. Preferably, each socket is oriented generally perpendicularly to an adjacent socket.

Preferably, the plurality of sockets are configured generally in a row.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

In order that the invention may be more fully understood, some embodiments will now be described by way of example with reference to the accompanying figures in which:

FIG. 1 is a perspective view of a preferred form power receptacle;

FIG. 2 is a front elevation view of the receptacle of FIG. 1, showing the use of various plugs and sockets;

FIG. 3a-d show examples of different plug configurations that can be used with the power receptacle;

FIG. 4 is an exploded perspective view of the power receptacle;

FIG. 5 is a perspective view showing the power receptacle in a standing configuration;

FIG. 6 is a perspective view showing the power receptacle in a lying configuration;

FIG. 7 is a perspective view showing the power receptacle in use;

FIGS. 8a, 8b, and 8c are top, front, and side elevation views respectively of the preferred form power receptacle; and

FIG. 9 is a perspective view of an alternative preferred form power receptacle.

### DETAILED DESCRIPTION OF PREFERRED FORMS

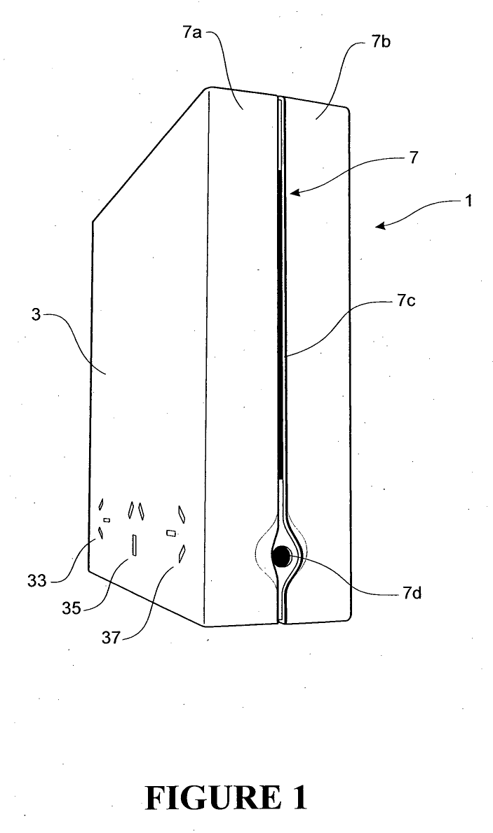

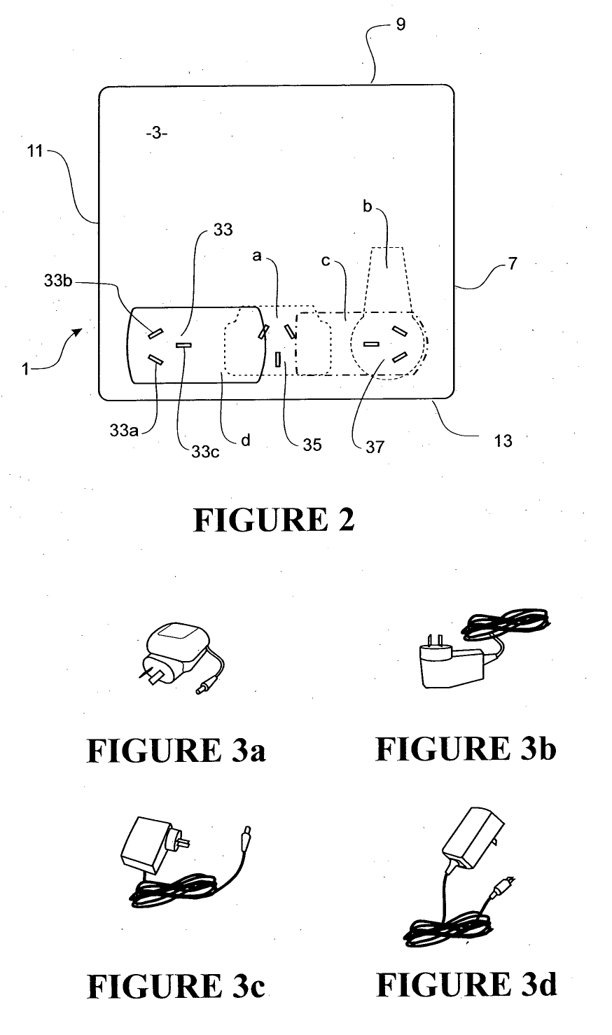

Referring to FIGS. 1 and 2, the preferred form power receptacle for delivering power to at least one device to be powered, is indicated by reference numeral 1. The receptacle has a casing with a plurality of exterior walls, namely front wall 3, rear wall 5, and side walls 7, 9, 11, and 13. Each of the walls defines an exterior surface of the power receptacle. The power receptacle is a stand alone self-supporting unit that is suitable for desktop use.

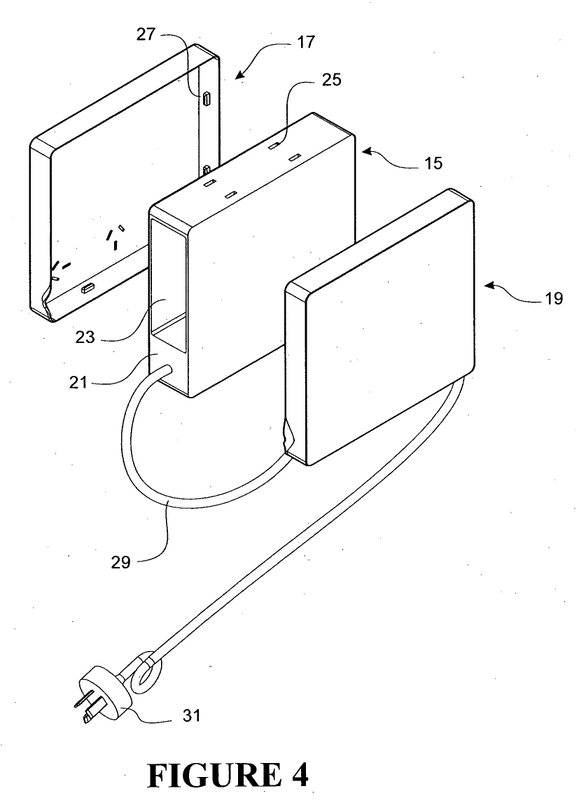

As shown in FIG. 4, the casing is defined by an internal support frame 15 that is received in front and rear shells 17, 19. The support frame includes an integral power supply section 21 and an internal cavity 23. The internal cavity may extend into only one side of the support frame, or alternatively could extend fully through the support frame. It is preferred that the cavity 23 forms a major part of the volume occupied by the support frame and thereby the casing. In an alternative design, the support frame could be excluded and the support structure could be an integral part of the casing.

The support frame comprises a number of notches 25 that are adapted to receive corresponding projections 27 within the shells 17, 19 to maintain those components in engagement. The notches and projections could be reversed, or any other type of engagement feature could be used. A power cord 29 is in electrical connection with sockets in the power supply section 21 to deliver power thereto. A proximal end of the power cord is wired into, or connectable to, the power supply section, and a distal end of the power cord is wired into a power plug 31. When the power plug is plugged into to a power socket such as a wall socket or an extension cord for example, power is delivered to the sockets in the power supply section.

The power cord 29 may be “hard wired” into the power supply section of the receptacle; that is it may be permanently connected to the power supply section of the receptacle. Alternatively, the power cord may be disconnectable from the receptacle, and optionally may be interchangeable with an alternative power cord for use in a different country for example.

When the support frame 15 is received and engaged in the shells 17, 19, the receptacle has the form shown in FIG. 1. The front shell 17 forms the front wall 3 and part of the four side walls 7, 9, 11, 13, and the rear shell 19 forms the rear wall 5 and the remaining part of the side walls 7, 9, 11, 13. It should be noted that the power cord has been excluded from that view for the sake of clarity.

The shells 17, 19 and the support frame 15 preferably have the configuration shown such that a gap is provided between the two shells around the entire casing. Alternatively, the gap may be provided along only the opening 7c. As another alternative the gap could, for example, be provided along more than one side wall but not all side walls.

The side wall 7 has two side wall portions 7a, 7b that define an opening 7c therebetween. The opening 7c provides access to the cavity 23 in the support frame of the casing from the exterior of the casing. A further opening 7d may be provided in the wall, and the receptacle power cord extends through that opening.

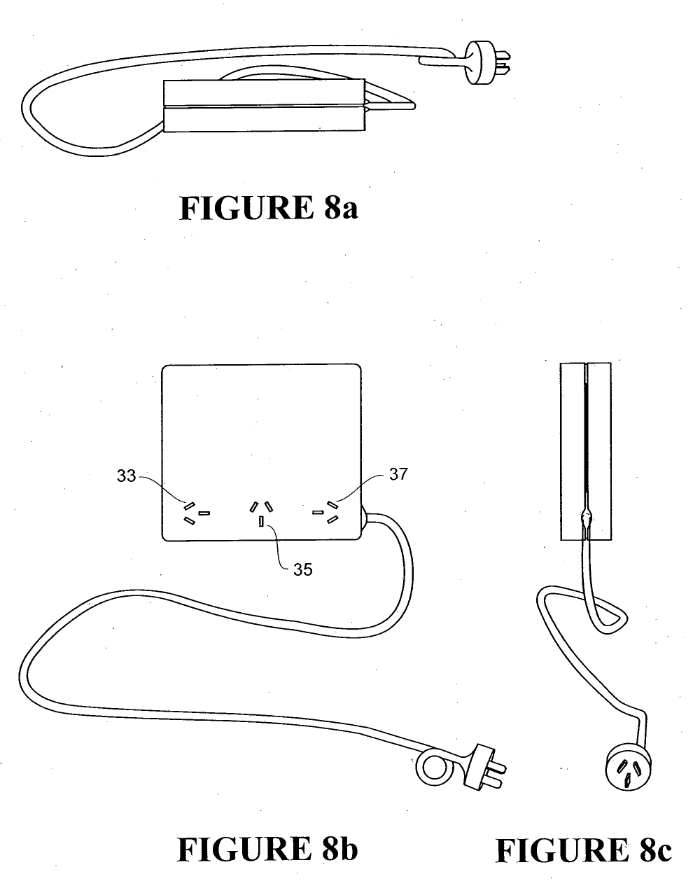

As can be seen from FIGS. 1, 2, and 8b, the front wall 3 comprises a number of sockets 33, 35, 37 each configured to receive a power plug of a device to be powered, to enable a plurality of devices to be powered at any one time. FIGS. 3a to 3b show examples of various devices that can be powered using the preferred form receptacle. The receptacle can be used to power any suitable electrical or electronic items, for example chargers or power supplies for laptop computers, mobile phones, personal music devices, digital cameras, or any other suitable item.

As can be seen from FIGS. 3a to 3d, the power plugs of those devices are part of adapters that have varying shapes and orientations relative to the pins of the plugs. To accommodate that, at least two of the sockets are preferably provided on different orientations in the wall to accommodate the plugs of different configurations. For example, the two sockets may be oriented generally perpendicularly to one another. The receptacle is preferably in the form shown, wherein the receptacle comprises at least three sockets, each of which is provided on a different orientation in the wall from the others. Preferably, each socket is oriented generally perpendicularly to any adjacent socket as shown. As indicated in FIG. 2, this enables the power plugs of the devices to be received in the sockets, and the adapters to not extend beyond any of the side walls of the receptacle. Therefore, the receptacle can be used in a standing configuration in which it rests on the side wall 13 as shown in FIG. 2.

Each socket has a plurality of apertures 33a, 33b, 33c of a known type for receipt of pins on the plugs of the devices to be powered. The apertures are in alignment with corresponding contacts (not shown) in the power supply section to deliver power from the power cord 29 to the sockets, and thereby to the pins of the device to be charged when its plug is inserted into the socket. The internal electrical connections between the contacts and the power cord 29 in the power supply section 21 can be of any type known to a skilled person, and will not be described in detail here.

The or each socket may be a “hot” socket. That is, when the receptacle is electrically connected to a power source, power is delivered to the socket. Alternatively, the or each socket may be switched, so power can be selectively delivered to the or each power source. A single switch may control all sockets, or individual switches may be provided for each socket. Alternatively, the receptacle may be provided with a combination of switched and hot sockets.

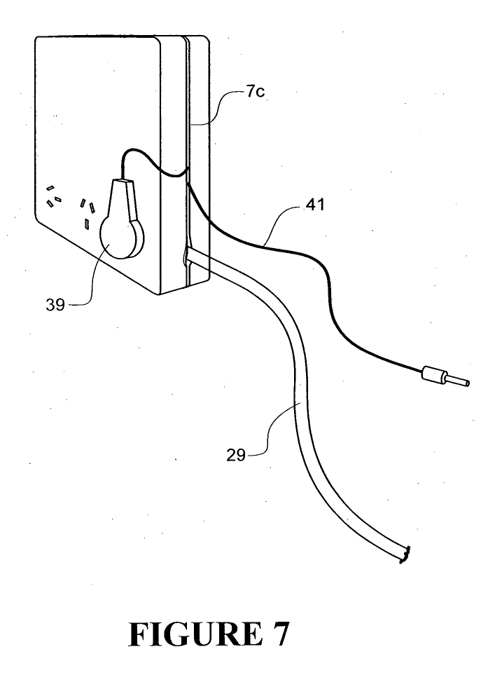

The cavity 23 is configured to receive part of the power cord of the device(s) when being powered by the receptacle as shown in FIG. 7. The power cord 41 extends from plug 39 into the cavity of the receptacle 1, through the opening 7c. The free end of the cord extends back out through the opening 7c, to be plugged into the device to be powered. Excess cable is retained in the cavity.

Wall portions 7a, 7b form flaps that at least partly cover the opening 7c to the cavity, and which define the opening therebewteen. The flaps are biased toward the closed position in which they at least partly cover the cavity, so that the flaps can apply pressure against the power cord extending through the opening to minimise undesired movement of the power cord. In the form shown, the flaps are formed of resilient material. The preferred material is an elastomer, such as rubber or an elastomeric polymer of any suitable type such as rubber, or any suitable elastomeric polymer such as TPU, latex, or silicon for example.

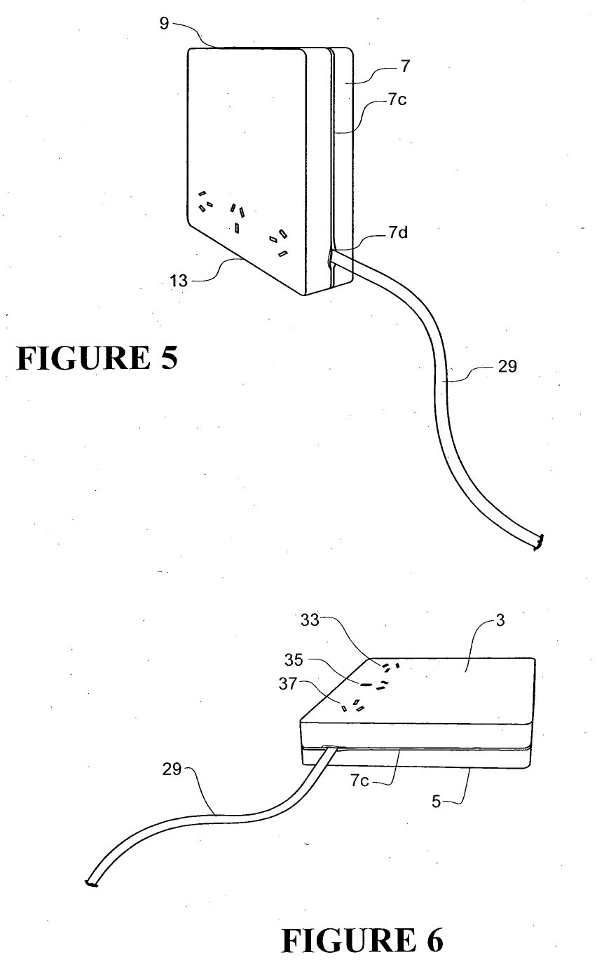

In the form shown, the opening 7c is an elongate slit that extends a major part of the length of the side wall. However, it will be appreciated that the opening could be shorter if desired. It is preferred that the opening is provided in a wall other than the rear wall, so the receptacle can be rested on its rear wall 5 as shown in FIG. 6 without the cables entering or exiting the housing interfering with that position. It is also preferred that the opening is provided in a wall other than the bottom side wall 13, so the receptacle can be rested on the bottom side wall 13 as shown in FIG. 5.

However, if desired, an opening can be provided in more than wall to feed power cords into the cavity. For example, an opening could be provided in one or more of front wall 3, side wall 7, top side wall 9, or side wall 11. The support frame will be configured with opening(s) corresponding in position to the opening(s) in the walls.

It is preferred that in the standing configuration of the device, the power supply section is provided at the lowest end of the receptacle so that the centre of gravity of the receptacle is low for stability purposes.

It is preferred that at least the front outer surface 3 of the casing is formed of an elastomeric material. All exterior surfaces of the casing may be formed of an elastomeric material. The elastomeric material may be rubber, or any suitable elastomeric polymer such as TPU, latex, or silicon for example. Each shell may be formed by co-moulding an elastomeric material for the outer surfaces with a different polymer for an inner supporting region of the shell. The inner supporting region of the shell may be formed from any suitable polymeric material that is approved for electrical use, such as ABS for example. In order that the flap(s) have satisfactory resilience, the flaps will generally be formed of only the elastomeric material without any inner supporting region.

The support frame will be made from a suitable polymer that is approved for electrical use, such as ABS for example.

By providing a front surface 3 having an enlarged resilient surface that is preferably planar, a support surface is provided to rest a device being powered when the receptacle is used on the orientation shown in FIG. 6. The material preferably has a relatively high coefficient of friction to assist in gripping the device resting on the receptacle, and to assist in gripping the cords extending into and out of the opening 7c. The rear surface 5 opposite the front surface 3 is preferably substantially planar and formed of a resilient material, to provide a surface upon which the power receptacle can rest.

The device may comprise an indicator to indicate when it is plugged in and powered. The indicator may comprise an LED for example. Preferably the LED is visible around the point of insertion of the power cord of the receptacle into the casing.

The device may be provided with an indicator (not shown) for the or each socket that indicates when a device is plugged into the socket(s) and is being powered. The indicator(s) may comprise LED(s) for example. The indicator(s) could be provided in any suitable external wall of the casing.

While in the form shown the receptacle casing is a cuboid shape, the receptacle casing could be an alternative shape. By way of example only, the front and rear surface could have a round or elliptical shape, and a single side wall could form a perimeter between the front and rear surfaces. However, it is preferred that the receptacle casing has the exterior shape shown or similar, so it can be rested on a desktop or similar on its rear wall, or can be positioned in an upright configuration on a shelf. Preferably, the wall opposite the wall with the socket(s) and the side wall closest to the socket(s) are each substantially planar.

The preferred form power receptacle described above provides a power receptacle in which the power socket(s) is/are readily accessible, and that offers integral storage for excess cord from device(s) being powered, thereby minimising cable clutter. Additionally, the preferred form power receptacle provides a support surface for a device being powered, and enables adapters of differing configurations to be used whether the receptacle is in a standing or lying configuration.

The above describes preferred forms of the present invention, and modifications can be made thereto without departing from the scope of the present invention.

For example, the device shown and described above has three power sockets to power multiple devices. Instead, the device may have a single power socket, or two, four, or more power sockets if desired.

The sockets shown in the figures are of the type used in Australia and New Zealand. The sockets can, of course, be modified for international markets. By way of example, for the US market, the sockets would be configured to receive a plug having two parallel flat blades, or two parallel flat blades with a round ground pin. For other countries, the sockets may be configured to receive two or three round pins, two or three rectangular blades, or any other suitable configuration.

In addition to providing power connections, the preferred form device could provide one or more data connections. By way of example, a plurality of data sockets could be provided in one or more surfaces of the power receptacle. The data socket(s) could be provided in the same surface as the power socket(s), or could be provided in a different surface. To ensure there is isolation between the data and power connections, the support frame may be provided with an integral power supply section, a separate integral data supply section, and the cavity for receipt of cables. In some embodiments, there may be two cavities—one for receipt of data cables and the other for receipt of power cables. Each section and/or cavity will be isolated from adjacent sections and/or cavities, by a polymeric wall for example. The polymeric wall may be an integral part of the support frame.

The data connections can be of any suitable type. For example, the power receptacle may comprise a plurality of USB sockets so the receptacle can act as a USB hub. Alternatively or in addition, the power receptacle may comprise a plurality of RJ45 ethernet connectors. Any other suitable data connections could be used.

In a similar manner to the power supply section, the data supply section inputs could be “hard wired” to a supply cable. Alternatively, one of the plurality of data sockets could provide the data supply input.

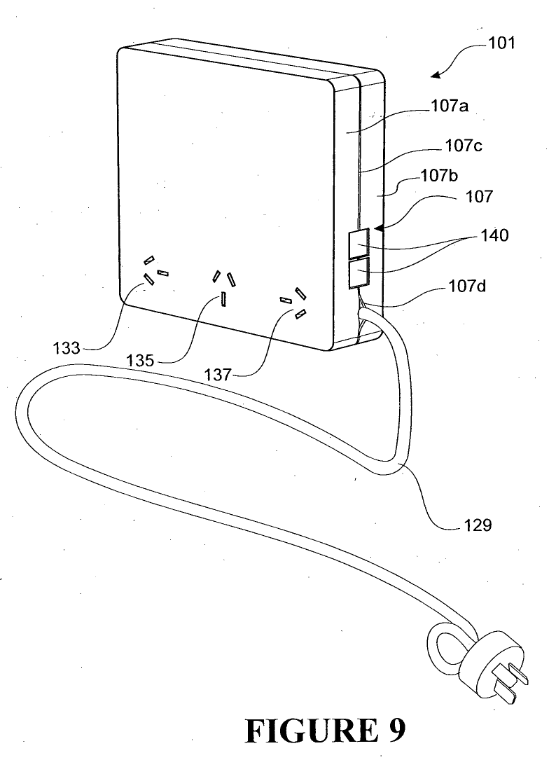

FIG. 9 shows an alternative preferred form of the present invention, which includes data sockets 140. In this form, the power receptacle includes two data sockets 140 in the wall above the opening 107d for receipt of the cord 129. In the form shown, two USB sockets are provided. The cord 129 may include a USB communication cable, USB power cable, and mains power cable, all within a single sheath. The remaining features should be considered the same as the embodiment described above, and like numerals are used to indicate like parts with the addition of 100.

Other example modifications are listed in the “Summary of the Invention” section.

1. A power receptacle suitable for desktop use for delivering power to at least one device to be powered, the power receptacle comprising: a casing having a plurality of exterior walls and a cavity within the casing, wherein the cavity is accessible from an exterior of the casing via an opening in the casing; and at least one socket in an exterior wall of the casing, the socket configured to receive a power plug of a device to be powered which plug is in electrical connection with a power cord for the device to be powered; wherein the cavity is configured to receive part of the power cord of the device to be powered.

2. A power receptacle as claimed in claim 1, wherein the casing comprises at least a front exterior wall and a rear exterior wall.

3. A power receptacle as claimed in claim 2, wherein the socket(s) is/are provided in the front exterior wall, and the opening for access to the cavity is provided in a portion of the casing other than the rear exterior wall.

4. A power receptacle as claimed in claim 3, wherein the casing further comprises at least one side exterior wall between the front exterior wall and the rear exterior wall, and the opening is provided in the side exterior wall.

5. A power receptacle as claimed in claim 1, wherein a major part of the casing is formed by the cavity.

6. A power receptacle as claimed in claim 5, wherein the socket(s) is/are provided in a power supply section at or toward an edge of the casing, and substantially the remainder of the interior of the casing comprises the cavity.

7. A power receptacle as claimed in claim 1, wherein the casing is provided with a flap to at least partly cover the opening to the cavity.

8. A power receptacle as claimed in claim 7, wherein the flap is biased toward a closed position in which it at least partly covers the cavity, so that the flap can apply pressure against a power cord extending through the opening to minimise undesired movement of the power cord.

9. A power receptacle as claimed in claim 8, wherein the flap is formed of a resilient material, and the resilience of the material biases the flap toward the closed position.

10. A power receptacle as claimed in claim 9, wherein the material is an elastomer.

11. A power receptacle as claimed in claim 7, wherein the casing comprises a pair of opposing flaps, and the flaps define the opening therebetween.

12. A power receptacle as claimed in claim 1, wherein the opening is an elongate slit that extends a major part of the length of a side wall.

13. A power receptacle as claimed in claim 1, comprising a plurality of sockets to enable a plurality of devices to be powered at any one time.

14. A power receptacle as claimed in claim 13, wherein the sockets are provided in a single exterior wall of the device.

15. A power receptacle as claimed in claim 14, wherein at least two of the sockets are provided on different orientations in that wall to accommodate plugs of different configurations.

16. A power receptacle as claimed in claim 15, wherein the two sockets are oriented generally perpendicularly to one another.

17. A power receptacle as claimed in claim 15, comprising at least three sockets, each of which is provided on a different orientation from the other sockets.

18. A power receptacle as claimed in claim 17, wherein each socket is oriented generally perpendicularly to an adjacent socket.

19. A power receptacle as claimed in claim 1, wherein at least one exterior surface of the casing is formed of an elastomeric material.

20. A power receptacle as claimed in claim 19, wherein the surface comprising the socket(s) is formed of an elastomeric material.

21. A power receptacle as claimed in claim 1, additionally configured to provide a data connection.

22. A power receptacle suitable for desktop use for delivering power to at least one device to be powered, the power receptacle comprising: a casing having a plurality of exterior walls; and at least one socket accessible from the exterior of the casing, the socket configured to receive a power plug of a device to be powered, wherein at least one exterior surface of the casing is formed of an elastomeric material.

23. A power receptacle as claimed in claim 22, wherein at least the exterior wall corresponding to the socket(s) is formed of an elastomeric material.

24. A power receptacle as claimed in claim 23, wherein the exterior wall corresponding to the socket(s) is generally planar, to provide a surface upon which at least one device to be powered can be supported.

25. A power receptacle as claimed in claim 24, wherein the exterior wall opposite the exterior wall corresponding to the socket(s) is generally planar, to provide a surface upon which the power receptacle can rest.

26. A power receptacle as claimed in claim 22, wherein the socket(s) is/are provided in a wall adjacent the edge of that wall, and an adjacent wall is generally planar, to provide a surface upon which the power receptacle can rest.

27. A power receptacle as claimed in claim 22, wherein all exterior walls of the casing are formed of an elastomeric material.

28. A power receptacle suitable for desktop use for delivering power to at least one device to be powered, the power receptacle comprising: a casing having a plurality of exterior walls; and a plurality of sockets in one of the exterior walls of the casing, wherein each socket is oriented in the wall on an angle relative to any adjacent socket, the sockets each configured to receive a power plug of a respective device to be powered.

29. A power receptacle as claimed in claim 28, wherein the socket is/are provided in a power supply section at or toward one edge of the casing.

30. A power receptacle as claimed in claim 28, wherein each socket is/are oriented generally perpendicularly to an adjacent socket.

31. A power receptacle as claimed in claim 28, comprising at least three sockets, each of which is provided on a different orientation from the other sockets.

32. A power receptacle as claimed in claim 31, wherein each socket is oriented generally perpendicularly to an adjacent socket.

33. A power receptacle as claimed in claim 28, wherein said plurality of sockets are configured generally in a row.
